(19) United States
(12) Patent Application Publication
(10) Pub. No.: US 2012/0206684 A1
(43) Pub. Date: Aug. 16, 2012

(54) LIQUID CRYSTAL DISPLAY AND MANUFACTURING METHOD THEREOF

(75) Inventors: Sang Wook LEE, Seoul (KR); Sung-Jun KIM, Seoul (KR); Jong-Young YUN, Gwangmyeong-si (KR); Ki Yong KIM, Taebaek-si (KR); Hwa-An SUNG, Namyangju-si (KR)

(73) Assignee: SAMSUNG ELECTRONICS CO., LTD., Suwon-si (KR)

(21) Appl. No.: 13/197,926

(22) Filed: Aug. 4, 2011

(30) Foreign Application Priority Data
Feb. 14, 2011 (KR) 10-2011-0012971

(51) Int. Cl. G02F 1/1343; H01J 9/24

(52) U.S. Cl. 349/139; 445/24

(57) ABSTRACT

A liquid crystal display includes a first substrate including a display area and a fan-out area, a plurality of pixels disposed in the display area; a dam disposed in the fan-out area, and a plurality of display signal lines disposed on the first substrate, where the plurality of display signal lines is connected to the plurality of pixels in the display area, the plurality of display signal lines includes a plurality of wiring units in the fan-out area, the dam is disposed in a dummy area between the plurality of wiring units, and a shape of the dam is different from a shape of the plurality of wiring units.

This application claims priority to Korean Patent Application No. 10-2011-0012971, filed on Feb. 14, 2011, and all the benefits accruing therefrom under 35 U.S.C. §119, the content of which in its entirety is herein incorporated by reference.

### BACKGROUND OF THE INVENTION

(a) Field of the Invention

Exemplary embodiments of the invention relate to a liquid crystal display and a manufacturing method of the liquid crystal display.

(b) Description of the Related Art

A liquid crystal display (“LCD”) is one of the most widely used types of flat panel displays. The LCD includes two display panels provided with electric field generating electrodes, and a liquid crystal layer interposed between the two display panels. In the LCD, voltages are applied to the electric field generating electrodes to generate an electric field in the liquid crystal layer. Due to the generated electric field, liquid crystal molecules of the liquid crystal layer are aligned, and polarization of incident light passing therethrough is controlled, thereby displaying images.

In general, the LCD includes a pixel including a switching element, for example, a thin film transistor (“TFT”) that is a three terminal element, and a display panel including display signal lines including a gate line and a data line. The thin film transistor functions as a switching element for transmitting a data signal transmitted through the data line to the pixel or intercepting the pixel according to a gate signal transmitted through the gate line.

The display panel of the LCD includes a display area including pixels for displaying image signals and a non-display area. The non-display area typically includes elements for driving the LCD. In the display panel, the display area may be increased and the non-display area may be decreased to effectively increase the size of the LCD.

Also, a tiled display realized by LCDs that are arranged in a matrix, such as 3×3 or 4×4 matrix, for example, has been spotlighted. The tiled display of a large size may be realized using a plurality of LCDs, and the tiled display device may be applied to various fields.

However, when the width of the bezel disposed between LCDs, which may corresponds to the non-display area of the LCD panel, is wide, an image on the tilted display may look unnatural due to the connection of the LCDs therein.

### BRIEF SUMMARY OF THE INVENTION

Exemplary embodiments of the present invention provide a liquid crystal display with reduced non-display area, and a manufacturing method of the liquid crystal display.

An exemplary embodiment of the present invention provides a liquid crystal display including: a first substrate including a display area and a fan-out area; a plurality of pixels disposed in the display area; a dam disposed in the fan-out area; and a plurality of display signal lines disposed on the first substrate, where the plurality of display signal lines is connected to the plurality of pixels in the display area, the plurality of display signal lines includes a plurality of wiring units in the fan-out area, the dam is disposed in a dummy area of the fan-out area between the plurality of wiring units, and a shape of the dam is different from a shape of the plurality of wiring units.

In an exemplary embodiment, a height of the dam with respect to the first substrate may be greater than or equal to a height of the plurality of wiring units with respect to the first substrate.

In an exemplary embodiment, each of each of the plurality of pixels may include a switching element, and the switching element is formed by stacking a plurality of layers on the first substrate.

In an exemplary embodiment, the dam may be formed by the plurality of layers stacked on the first substrate.

In an exemplary embodiment, the liquid crystal display may further include: a gate conductor disposed on the first substrate and including a first conductor, a gate line, and a gate electrode connected to the gate line; a gate insulating layer disposed on the substrate and the gate conductor; a data conductor disposed on the gate insulating layer and including a second conductor, a data line, a drain electrode, and a source electrode connected to the data line; and a passivation layer disposed on the gate insulating layer and the data conductor, where the switching element includes the gate electrode, the drain electrode and the source electrode, and the dam includes the first conductor, the gate insulating layer, the second conductor and the passivation layer.

In an exemplary embodiment, the switching element may further include a first semiconductor, and the first semiconductor may be disposed on the gate insulating layer and overlapping on the drain electrode and the source electrode.

In an exemplary embodiment, the dam may further include a semiconductor island, and the semiconductor island may be disposed between the gate insulating layer and the second conductor.

In an exemplary embodiment, each of the plurality of pixels may further include a pixel electrode, and the pixel electrode may be disposed on the passivation layer and is electrically connected to the drain electrode.

In an exemplary embodiment, the liquid crystal display may further include an alignment layer disposed on the passivation layer and the pixel electrode.

In an exemplary embodiment, the plurality of display signal lines may include the gate line and the data line.

In an exemplary embodiment, t planar shape of the dam may be a polygon, and a planar shape of the dummy area may be substantially similar to the planar shape of the dam.

In an exemplary embodiment, the planar shape of the dam may be trapezoidal or triangular.

In an exemplary embodiment, a side of the dam adjacent to a boundary of the display area and the fan-out area may be substantially parallel to the boundary of the display area and the fan-out area.

In an exemplary embodiment, the dam may include a first dam and a second dam, and a distance between the first dam and the second dam may be greater than a distance between the dam and an adjacent display signal line of the plurality of display signal lines.

In an exemplary embodiment, the liquid crystal display may further include a second substrate disposed opposite to the first substrate, a liquid crystal layer disposed between the first substrate and the second substrate, and a sealant which bonds the first substrate and the second substrate.

In an exemplary embodiment, the liquid crystal display may further include a common electrode disposed on the second substrate.

In an exemplary embodiment, the sealant may include a short bar, and the short bar may be connected to the common electrode of the second substrate.

In an exemplary embodiment, the short bar may be disposed in the dummy area.

In an exemplary embodiment, the dam may include at least one dam disposed between the display area and the short bar.

In an exemplary embodiment, the dam may be disposed to surround the short bar.

Another embodiment of the present invention provides a method for manufacturing a liquid crystal display, including: providing a plurality of pixels in a display area on a first substrate including the display area and a fan-out area; providing a dam in the fan-out area; and providing a plurality of display signal lines including a plurality of gate lines and a plurality of data lines crossing the plurality of gate lines in an insulated manner on the first substrate, where the display signal lines are connected to the plurality of pixels in the display area, the plurality of display signal lines includes a plurality of wiring units in the fan-out area, the dam is disposed in a dummy area of the fan-out area between the plurality of wiring units, and a shape of the dam is different from a shape of the plurality of wiring units.

In an exemplary embodiment, the method may further include: providing a gate conductor including a first conductor, a gate line and a gate electrode connected to the gate line on the first substrate; providing a gate insulating layer on the first substrate and the gate conductor; providing a data conductor including a second conductor, a data line, a drain electrode and a source electrode connected to the data line on the gate insulating layer; and providing a passivation layer on the gate insulating layer and the data conductor, where each of the plurality of pixels includes the gate electrode, the drain electrode and the source electrode, and the dam includes the first conductor, the gate insulating layer, the second conductor and the passivation layer.

In an exemplary embodiment, the method may further include providing an alignment layer in the display area over the passivation layer.

In an exemplary embodiment, the method may further include providing a sealant including a short bar on the first substrate, where the short bar is disposed in the dummy area.

In an exemplary embodiment, the method may further include providing a common electrode on the second substrate, bonding the first substrate and the second substrate to each other through the sealant, and providing a liquid crystal layer between the first substrate and the second substrate.

In an exemplary embodiment, the short bar may be connected to the common electrode by bonding the first substrate and the second substrate.

According to the exemplary embodiments of the present invention, a liquid crystal display with reduced non-display area and a manufacturing method thereof are provided.

### BRIEF DESCRIPTION OF THE DRAWINGS

The above and other aspects, advantages and features of the invention will become more apparent by describing in further detail exemplary embodiments thereof with reference to the accompanying drawings, in which:

FIG. 1 is a top plan view of an exemplary embodiment of a liquid crystal display according to the present invention;

FIG. 2 is a partial enlarged view of the liquid crystal display shown in FIG. 1;

FIG. 3 is a cross-sectional view taken along line III-III′ and line III′-III″ of the liquid crystal display in FIG. 2 when a display signal line of FIG. 2 is a gate line 121;

FIG. 4 is a cross-sectional view taken along line IV-IV′ and line IV′-IV″ of the liquid crystal display in FIG. 2 when a display signal line of FIG. 2 is a data line;

FIG. 5 is a top plan view of a pixel of a liquid crystal display;

FIG. 6 is a cross-sectional view taken along line VI-VI of the liquid crystal display of FIG. 5;

FIGS. 7 to 18 are cross-sectional views showing an exemplary embodiment of a method for manufacturing a lower panel of the liquid crystal display in FIGS. 3 and 6;

FIG. 19 is a plan view of an exemplary embodiment of a liquid crystal display, where no dam is provided in a dummy area;

FIG. 20 is a plan view of an alternative exemplary embodiment of a tiled display including a plurality of liquid crystal displays connected to each other;

FIG. 21 is a top plan view of an alternative exemplary embodiment of the liquid crystal display shown in FIG. 1; and

FIG. 22 is a top plan view of another exemplary embodiment of a liquid crystal display shown in FIG. 1.

### DETAILED DESCRIPTION OF THE INVENTION

The invention will be described more fully hereinafter with reference to the accompanying drawings, in which exemplary embodiments of the invention are shown. As those skilled in the art would realize, the described embodiments may be modified in various different ways, all without departing from the spirit or scope of the invention.

In the drawings, the thickness of layers, films, panels, areas, etc., are exaggerated for clarity. Like reference numerals designate like elements throughout the specification. It will be understood that when an element such as a layer, film, area, or substrate is referred to as being “on” another element, it can be directly on the other element or intervening elements may also be present. In contrast, when an element is referred to as being “directly on” another element, there are no intervening elements present.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” or “under” relative to other elements or features would then be oriented “upper” or “above” relative to the other elements or features. Thus, the exemplary term “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, an exemplary embodiment of a liquid display according to the present invention will be described in detail with reference to the accompanying drawings.

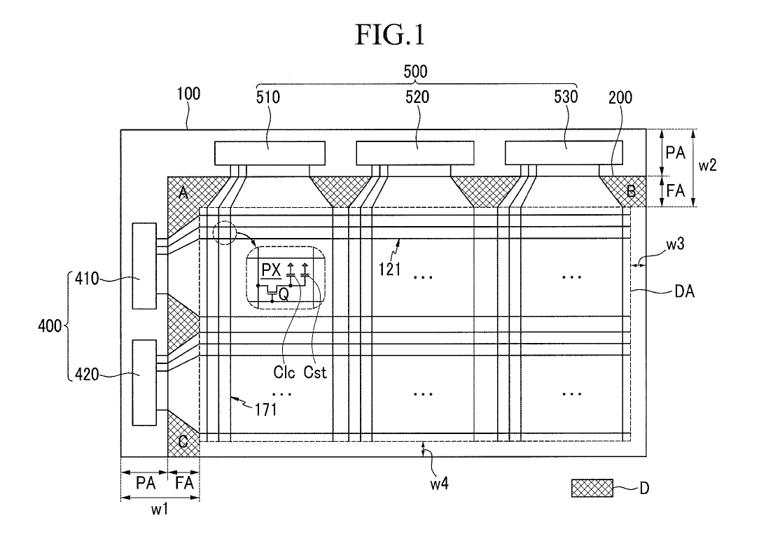

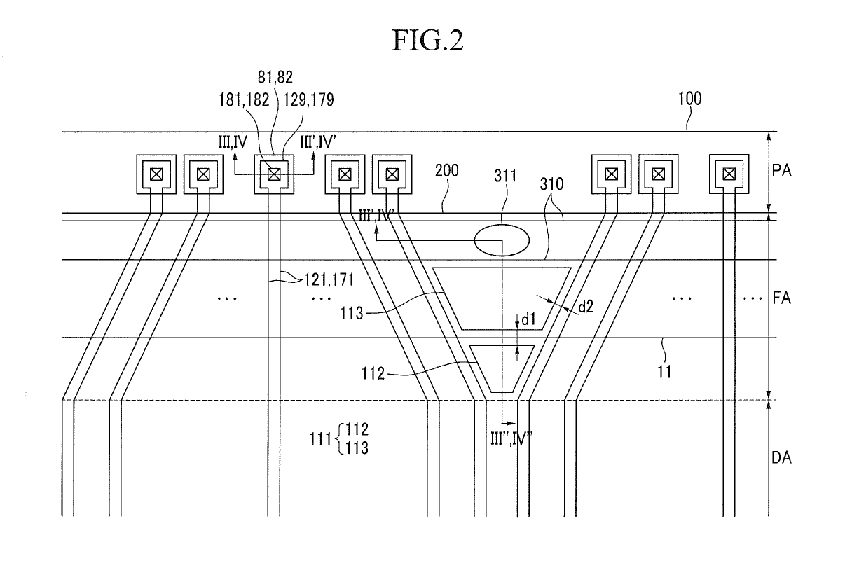

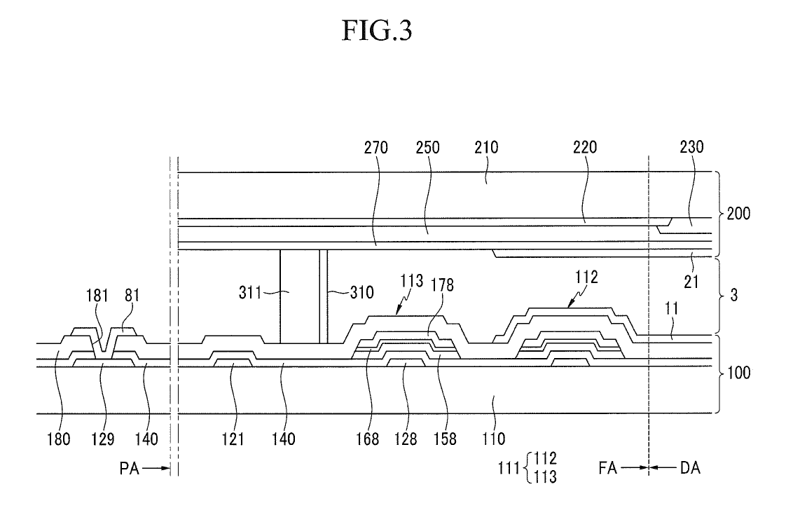

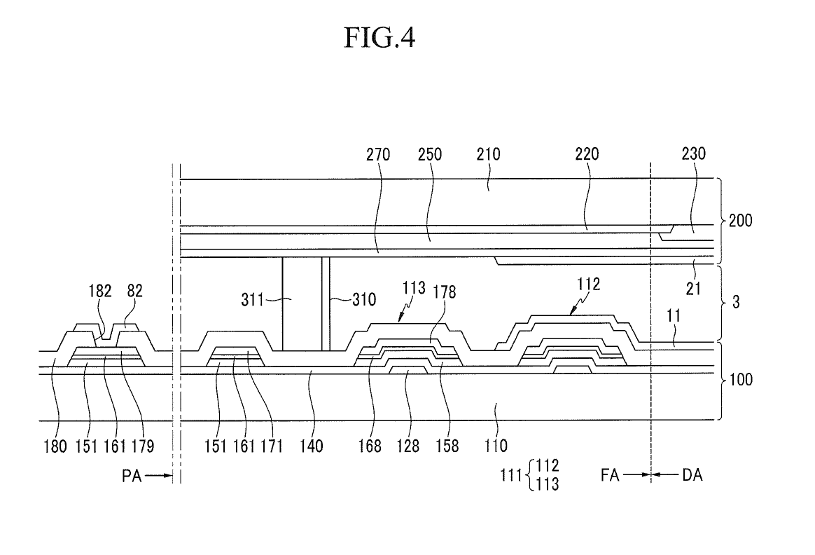

FIG. 1 is a top plan view of an exemplary embodiment of a liquid crystal display according to the present invention, FIG. 2 is a partial enlarged view of the liquid crystal display shown in FIG. 1, FIG. 3 is a cross-sectional view taken along line III-III′ and line III′-III″ of the liquid crystal display shown in FIG. 2 when a display signal line of FIG. 2 is a gate line, and FIG. 4 is a cross-sectional view taken along line IV-IV′ and line IV′-IV″ of the liquid crystal display in FIG. 2 when the display signal line of FIG. 2 is a data line.

Referring to FIGS. 1 to 4, the liquid crystal display includes a lower panel 100 and an upper panel 200 disposed opposite to, e.g., facing, each other, a liquid crystal layer 3, which may be provided by injecting liquid crystal between the lower and upper panels 100 and 200, and a sealant 310 that bonds the lower and upper panels 100 and 200 to each other. A switching element Q and display signal lines including a gate line 121 and a data line 171 are disposed on the lower panel 100. The sealant 310 includes a short bar 311 including a conductive material. A polarizer (not shown) may be provided outside the display panels 100 and 200.

The lower panel 100 includes a display area DA for displaying an image signal and a non-display area around the display area DA. The non-display area includes a fan-out area FA and a pad area PA.

In the pad area PA, the display signal lines 121 and 171 are connected to drivers such as a gate driver 400 and a data driver 500, for example. The drivers supply a gate signal, a data signal, a control signal, a common voltage and power for driving the liquid crystal display. In an exemplary embodiment, the gate driver 400 includes a plurality of gate driver integrated circuits (“IC”s) 410 and 420, and the data driver 500 includes a plurality of data driver ICs 510, 520 and 530. In FIG. 1, two gate driver ICs 410 and 420 and three data driver ICs 510, 520 and 530 are shown for convenience of description, but the number of the gate driver ICs 410 and 420 and the number of the data driver ICs 510, 520, and 530 are not limited thereto.

In an exemplary embodiment, the driver may be directly installed in the pad area PA of the lower panel 100 in at least one IC chip form. In an alternative exemplary embodiment, the driver may be installed in a flexible printed circuit film (not shown) attached to the pad area PA in a tape carrier package (“TCP”) form. In an exemplary embodiment, the driver may be installed in an additional printed circuit board (“PCB”) (not shown) attached to the pad area PA. In an exemplary embodiment, the driver may be integrated with the display signal lines 121 and 171 and the switching element Q.

The pad area PA may be defined as an area of the lower panel 100 that is exposed by not overlapping the upper panel 200 in the top plan view, as shown in FIGS. 3 and 4. The upper panel 200 may be smaller than the lower panel 100 by the size of the pad area PA.

Pads 81 and 82 that electrically connect the display signal lines 121 and 171 with the driver are disposed in the pad area PA. The pads 81 and 82 are also referred to as “contact assistants”.

In the pad area PA, the pads 81 and 82 connected to a plurality of driver ICs, such as the gate driver ICs 410 and 420 and the data driver ICs 510, 520 and 530, are disposed substantially close to each other, and the display signal lines 121 and 171 are also disposed substantially close to each other.

In an exemplary embodiment, the gap between the display signal lines 121 and 171 provided in the display area DA have a width that is determined based on the size of the pixel PX. In an exemplary embodiment, a gap between the display signal lines 121 and 171 in the display area DA is greater than a gap between the display signal lines 121 and 171 in the pad area PA. Hence, an area in which a gap between the display signal lines 121 and 171 is gradually increased is provided between the pad area PA and the display area DA. The area between the pad area PA and the display area DA will be referred to as “fan-out” area FA.

The display signal lines 121 and 171 connected to the plurality of driver ICs in the fan-out area FA define a trapezoidal wiring unit. An area in the fan-out area FA except an area corresponding to the wiring unit will be referred to as a dummy area D.

A dam member 111 including at least one dam 112 and 113 is disposed in the dummy area D. Also, the short bar 311 may be disposed in the dummy area D.

The dam member 111 includes the at least one dam 112 and 113 and the short bar 311 in the fan-out area FA. In an exemplary embodiment, the at least one dam may include two dams 112 and 113 between the display area DA and the short bar 311, as shown in FIG. 2, but not being limited thereto. In an exemplary embodiment, the number of the dams 112 and 113 between the display area DA and the bar 311, and a gap between the dams 112 and 113 depend on the size of the fan-out area. Accordingly, the number of dams 112 and 113 and the gap between the dams 112 and 113 may vary based on the size of the fan-out area.

FIG. 2 shows a triangular dummy area D between the two trapezoidal wiring units. The dams 112 and 113 in the dummy area D have a shape different from a shape of the display signal lines 121 and 171 of the wiring unit. A planar shape and a width of the dams 112 and 113 are different from a planar shape and a width e of the display signal lines 121 and 171 of the wiring unit. The planar shape of the dams 112 and 113 may be polygonal. When the planar shape of the dams 112 and 113 is polygonal, a side adjacent to the boundary of the display area DA may be provided parallel to the boundary of the display area DA in the polygon. The planar shape of the dams 112 and 113 may be substantially the same as or similar to the planar shape of the dummy area D. The planar shape of dams 112 and 113 may be trapezoidal, and the planar shape of the dam 112 adjacent to the display area DA may be substantially triangular.

A gap d1 between the dams 112 and 113 may greater than a gap d2 between the dams 112 and 113, and the display signal lines 121 and 171 adjacent to the dams 112 and 113.

Referring back to FIG. 1, in addition to the dummy area D between the two adjacent wiring units, the dummy area D also includes an area A between a wiring unit connected to the gate driver IC 410 and the data driver IC 510, an area B below a wiring unit connected to the gate driver IC 420, and an area C of the wiring unit connected to the data driver IC 530. In an exemplary embodiment, the dam may be formed in the areas A, B and C of FIG. 1.

In an exemplary embodiment, the display signal lines 121 and 171, and additional signal wires for transmitting a control signal, a common voltage, and power may be disposed on the lower panel 100. The additional signal wires in addition to the display signal lines 121 and 171 may collectively define the wiring unit in the areas A, B and C in the fan-out area FA. In such an embodiment, no dam may be provided in the areas A, B and C.

Referring to FIGS. 1 to 4, a non-display area in connection with the structures of the dams 112 and 113 will now be described with primary reference to FIGS. 3 and 4. FIG. 3 shows a cross-sectional view when a display signal line of FIG. 2 is a gate line 121, and FIG. 4 shows a cross-sectional view when a display signal line of FIG. 2 is a data line 171.

An exemplary embodiment of the lower panel 100 will now be described.

Gate conductors 121 and 128 are disposed, e.g., formed, on an insulation substrate 110 made of transparent glass or plastic. The gate conductors 121 and 128 include a gate line 121 and a first conductor 128. The gate line 121 includes an end part 129 with an expended width, through which the gate line 121 may be connected to another layer or the gate driver 400. In the display area DA, the gate line 121 is generally extended in a horizontal direction. The end part 129 of the gate line 121 is formed in the pad area PA. The first conductor 128 is formed in the dummy area D of the fan-out area FA.

The gate conductors 121 and 128 are made of metal with low resistance including metals of aluminum (Al) such as aluminum or an aluminum alloy, metals of silver (Ag) such as silver or a silver alloy, and metals of copper (Cu) such as copper or a copper alloy.

A gate insulating layer 140 is disposed on the gate conductors 121 and 128. The gate insulating layer 140 is made of an organic insulator or an inorganic insulator.

A semiconductor including a semiconductor stripe 151 and a semiconductor island 158 made of hydrogenated amorphous silicon (“a-Si”) or polysilicon is disposed on the gate insulating layer 140. A semiconductor island 158 is disposed on the first conductor 128 in the dummy area D.

An ohmic contact stripe 161 is disposed on the semiconductor stripe 151, and an ohmic contact island 168 is disposed on the semiconductor island 158. The ohmic contacts 161 and 168 are made of a material such as n+ hydrogenated a-Si, to which the n-type impurity is doped in a high concentration, or a silicide.

A data conductor including a data line 171 and a second conductor 178 is disposed on the ohmic contacts 161 and 168.

The data line 171 includes an end part 179 with an expanded width, through which the data line may be connected to another layer or the data driver 500. In the display area DA, the data line 171 extends in a direction crossing the gate line 121. In an exemplary embodiment, the data line 171 may extend in a vertical direction. The end part 179 of the data line 171 is disposed in the pad area PA. The second conductor 178 is disposed on the ohmic contact island 168 in the dummy area D.

The data conductors 171 and 178 are made of refractory metals such as molybdenum, chromium, tantalum, and titanium, or the alloys thereof, and may have a multilayered structure including a refractory metal layer (not shown) and a low-resistance conductive layer (not shown). In an exemplary embodiment, the data conductors 171 and 178 may be made of a material substantially identical to a material included in the gate conductors 121 and 128.

A passivation layer 180 is disposed on the data conductors 171 and 178 and the gate insulating layer 140. In the pad area PA, a contact hole 182 for revealing the end part 179 of the data line 171 is disposed in the passivation layer 180. Also, in the pad area PA, a contact hole 181 which exposes the end part 129 of the gate line 121 is disposed in the passivation layer 180 and the gate insulating layer 140.

The first conductor 128, the gate insulating layer 140, the semiconductor island 158, the ohmic contact island 168, the second conductor 178 and the passivation layer 180 disposed in the dummy area D collectively define the dams 112 and 113. The dams 112 and 113 are electrically insulated from other areas such as the wiring unit and other members. As shown in FIGS. 3 and 4 , the gate insulating layer 140 and the passivation layer 180 also disposed between the dam 112 and the dam 113 and between the dams 112 and 113 and the adjacent wiring unit. The gate insulating layer 140 and the passivation layer 180 therebetween may be omitted to expose a portion of the substrate 110.

FIGS. 3 and 4 show structures of an exemplary embodiment of the dams 112 and 113. The dams 112 and 113 may be defined by a plurality of layers that are stacked on the substrate 110 to form the display signal lines 121 and 171 and the switching element Q of the display area DA. The dams 112 and 113 may be defined by at least a portion of a plurality of layers forming the switching element Q. In such an embodiment, a height of the dams 112 and 113 with respect to the substrate 110 may be greater than or equal to a height of the neighboring wiring unit disposed adjacent to the dams 112 and 113 with respect to the substrate 100.

A plurality of pads 81 and 82 are disposed on the passivation layer 180. The pads 81 and 82 are made of a transparent conductor such as indium tin oxide (“ITO”) or indium zinc oxide (“IZO”).

The pads 81 and 82 are connected to the end part 129 of the gate line 121 and the end part 179 of the data line 171, respectively, through the contact holes 181 and 182. The pads 81 and 82 provide adhesiveness between the end part 129 of the gate line 121 and external devices such as the drivers 400, or between the end part 179 of the data line 171 and external devices such as the drivers 500.

An alignment layer 11 is disposed on the passivation layer 180. The alignment layer 11 may be a vertical alignment layer.

In an exemplary embodiment, the alignment layer 11 to be disposed in the display area DA may be spread outside the display area DA during a manufacturing process. The dams 112 and 113 in the dummy area D form a step in the dummy area D, and the alignment layer 11 is effectively prevented from being spread because of the step. In such an embodiment, spreading of the alignment layer 11 outside the display area DA is substantially reduced, or effectively prevented by the dams 112 and 113.

The dam 112 adjacent to the display area DA effectively prevents the alignment layer 11 from being spread outside the display area DA during the manufacturing process thereof. The gap between the two dams 112 and 113 has a low step to further prevent the alignment layer 11 from spreading.

The planar shape of the dams 112 and 113 include a side adjacent to and substantially parallel to a boundary of the display area DA. The side parallel to the boundary of the display area DA is substantially vertical with respect to the progressing direction of the alignment layer 11, thereby interrupting the flow of the alignment layer 11.

Also, the gap d1 between the dams 112 and 113 may be wider than the gap d2 between the dams 112 and 113, and adjacent display signal lines 121 and 171. Accordingly, the alignment layer 11 is gathered between the dams 112 and 113, and thereby effectively preventing the alignment layer 11 from progressing between the dams 112 and 113, and the adjacent display signal lines 121 and 171.

The upper panel 200 will now be described.

Regarding the upper panel 200, a plurality of light blocking members 220 referred to as a black matrix and a plurality of color filters 230 disposed apart from each other with a predetermined interval are disposed on an insulation substrate 210, and an overcoat 250 is disposed on the light blocking members 220 and the color filters 230. The light blocking members 220 may be further disposed on the lower panel 100.

A common electrode 270 made of a transparent conductor or metal such as ITO or IZO is disposed on the overcoat 250, and an alignment layer 21 is disposed on the common electrode 270. The alignment layer 21 may be a vertical alignment layer.

The lower panel 100 and the upper panel 200 are bonded by a sealant 310. The sealant 310 is disposed on one of the lower panel 100 and the upper panel 200, and a liquid crystal layer 3 is disposed in a space corresponding to the sealant 310.

The liquid crystal layer 3 between the lower panel 100 and the upper panel 200 includes liquid crystal molecules having dielectric anisotropy. The liquid crystal molecules are aligned such that longitudinal axes thereof may be arranged vertically respect to the surfaces of the display panels 100 and 200 when no electric field is generated in the liquid crystal layer 3.

A short bar 311 included in the sealant 310 is not connected to a driver (not shown) on the lower panel 100, but connected to the common electrode 270 of the upper panel 200. The short bar 311 transmits the common voltage to the common electrode 270.

When the alignment layers 11 and 21 overlap the short bar 311, the lower panel 100 and the upper panel 200 may be short-circuited or resistance of the short bar 311 may be increased. Regarding the lower panel 100, spreading of the alignment layer 11 during the manufacturing process thereof is effectively prevented by the dams 112 and 113 in the dummy area D such that overlapping of the alignment layer 11 and the short bar 311 is effectively prevented.

The upper panel 200 is substantially planar, and the spreading degree of the alignment layer 21 outside the display area DA may be thereby effectively controlled.

FIG. 1 shows an exemplary embodiment of the liquid crystal display, in which a fan-out area FA and a pad area PA are disposed in a left side portion of the non-display area and an upper portion of the non-display area of the liquid crystal display, but not being limited thereto. In an alternative exemplary embodiment, the fan-out area FA and the pad area PA may be disposed in a right side portion of the non-display area and a lower portion of the non-display area of the liquid crystal display.

The display area DA may be increased and the non-display area may be decreased to realize a large-size display. However, when the fan-out area FA and the pad area PA are disposed in the right side portion and the upper portion of the non-display area, as shown in FIG. 1, widths w1 and w2 of the left side portion of the non-display area and the upper portion of the non-display area become greater than widths w3 and w4 of the right side portion of the non-display area and the lower portion of the non-display area.

When spreading of the alignment layer 11 is substantially reduced by the dams 112 and 113 in the dummy area D of the fan-out area FA, the widths w1 and w2 of the left side portion and the upper portion of the non-display area may be substantially reduced and the non-display area of the liquid crystal display is thereby substantially reduced.

A display area DA will now be described.

The display area DA corresponds to an area, in which a plurality of pixels PXs arranged in a matrix form is disposed, and the display area DA is also referred to as a pixel area. In an exemplary embodiment, each of the pixels PXs includes a switching element Q, e.g., a thin film transistor (“TFT”), a liquid crystal capacitor Clc, and a storage capacitor Cst. In an alternative exemplary embodiment, the storage capacitor Cst may be omitted.

The switching element Q provided on the lower panel 100 has three terminal elements including a control terminal and an input terminal connected to the gate line 121 and the data line 171, respectively, and an output terminal connected to the liquid crystal capacitor Clc and the storage capacitor Cst. The gate line 121 transmits a gate signal for turning on/off the switching element Q, and the data line 171 transmits a data signal corresponding to an image signal.

The liquid crystal capacitor Clc is defined by a pixel electrode (not shown) of the lower panel 100 and a common electrode 270 of the upper panel 200 as two terminals thereof with the liquid crystal layer 3 between the pixel electrode and the common electrode 270 that functions as a dielectric material. The pixel electrode is connected to the switching element Q, and the common electrode 270 is disposed on the surface of the upper panel 200 and receives the common voltage. The common electrode 270 is connected to the short bar 311. The common electrode receives the common voltage through the short bar 311.

The storage capacitor Cst is formed by an additional signal line (not shown), provided on the lower panel 100 and overlapping the pixel electrode, and a predetermined voltage such as the common voltage is applied to the additional signal line. Further, the storage capacitor Cst may be formed by the pixel electrode overlapping the previous gate line 121 with the insulator as a medium.

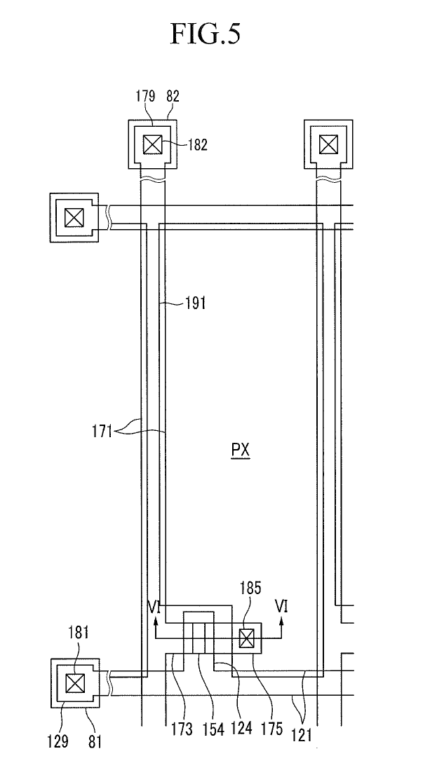

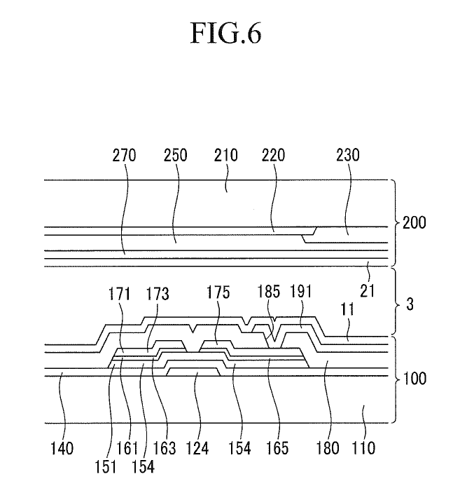

A pixel PX in the display area DA will now be described in detail with reference to FIGS. 5 and 6.

FIG. 5 is a top plan view of an exemplary embodiment of a pixel of a liquid crystal display, and FIG. 6 is a cross-sectional view taken along line VI-VI of the liquid crystal display of FIG. 5. The elements in FIG. 5 have been labeled with the same reference characters used to describe the same or like elements in FIGS. 3 and 4, and any repetitive detailed description thereof will hereinafter be omitted or simplified.

Referring to FIGS. 5 and 6, the liquid crystal display includes a lower panel 100 and an upper panel 200 disposed opposite to, e.g., facing, each other, and a liquid crystal layer 3 provided by injecting liquid crystal between the lower and upper panels 100 and 200.

The lower panel 100 will now be described.

A gate conductor including a gate line 121 is disposed on the insulation substrate 110 made of transparent glass or plastic. The gate line 121 includes a gate electrode 124 protruding upwardly and an end part 129 with an expanded width, through which the gate line is connected to another layer or the gate driver 400. The gate line 121 is extended substantially in the horizontal direction.

The gate conductor 121 is made of metal with low resistance including metals of aluminum (Al) such as aluminum or an aluminum alloy, metals of silver (Ag) such as silver or a silver alloy, and metals of copper (Cu) such as copper or a copper alloy.

A gate insulating layer 140 is disposed on the gate conductor 121. The gate insulating layer 140 is made of an organic insulator or an inorganic insulator.

A semiconductor including a plurality of semiconductor stripes 151 made of hydrogenated amorphous silicon or polysilicon is disposed on the gate insulating layer 140. The semiconductor stripes 151 are disposed substantially in the vertical direction, and the semiconductor stripe 151 includes a first semiconductor 154 extending towards the gate electrode 124.

A plurality of ohmic contact stripes 161 is disposed on the semiconductor stripes 151, and a pair of ohmic contacts 163 and 165 is disposed on the first semiconductor 154. The pair of ohmic contacts 163 is connected to the ohmic contact stripes 161.

The pair of ohmic contacts 163 and 165 is disposed opposite to each other with respect to the gate electrode 124. The ohmic contacts, e.g., the ohmic contact stripes and the pair of ohmic contacts 161, 163 and 165, are made of a material such as n+hydrogenated a-Si, to which the n-type impurity is doped in a high concentration, or a silicide.

Data conductors including a data line 171 and a drain electrode 175 are disposed on the ohmic contacts 161, 163 and 165.

The data line 171 transmits the data signal and extends substantially in the vertical direction and crossing the gate line 121. The data line 171 includes a source electrode 173 extending towards the gate electrode 124 and an end part 179 with an expanded width, through which the data line 171 is connected to another layer or the data driver 500. The drain electrode 175 is disposed at the top part of the gate electrode 124 with a predetermined gap from the source electrode 173.

The data conductors 171 and 175 are made of a refractory metal such as molybdenum, chromium, tantalum, and titanium, or their alloys, and may have a multilayered structure including a refractory metal layer (not shown) and a low-resistance conductive layer (not shown). In an exemplary embodiment, the data conductors 171 and 175 may be made of a material substantially the same as the material of the gate conductor 121.

The gate electrode 124, the first semiconductor 154, the source electrode 173 and the drain electrode 175 collectively define a thin film transistor with three terminal elements. A channel of the thin film transistor is disposed at the first semiconductor 154 between the source electrode 173 and the drain electrode 175.

The semiconductor stripe 151 including the first semiconductor 154 has a planar shape substantially the same as shapes of the data conductors 171 and 175, and the ohmic contacts 161 and 165, except at the channel area between the source electrode 173 and the drain electrode 175. That is, the semiconductor stripe 151 including an exposed part of the first semiconductor 154 that is not covered by the data conductors 171 and 175, e.g., a part between the source electrode 173 and the drain electrode 175.

A passivation layer 180 is disposed on the data conductors 171 and 175 and the exposed first semiconductor 154. A contact hole 185 that exposes the drain electrode 175 and a contact hole 182 that exposes the end part 179 of the data line 171 are formed in the passivation layer 180. A contact hole 181 that exposes the end part 129 of the gate line 121 is formed in the passivation layer 180 and the gate insulating layer 140.

A pixel electrode 191 and a plurality of pads 81 and 82 are disposed on the passivation layer 180. The pixel electrode 191 and the pads 81 and 82 are made of a transparent conductor such as ITO or IZO.

The pixel electrode 191 is substantially quadrangular and is connected to the drain electrode 175 through the contact hole 185. When the thin film transistor is turned on, the pixel electrode 191 receives a data signal from the drain electrode 175.

The pads 81 and 82 are connected to the end part 129 of the gate line 121 and the end part 179 of the data line 171 through the contact holes 181 and 182. The pads 81 and 82 provide adhesiveness between the end part 129 of the gate line 121 and drivers 400 of FIG. 1, or between the end part 179 of the data line 171 and drivers 500 of FIG. 1.

An alignment layer 11 is disposed on the pixel electrode 191 and the passivation layer 180. The alignment layer 11 may be a vertical alignment layer.

The upper panel 200 will now be described.

Regarding the upper panel 200, a light blocking member 220 referred to as a black matrix and a color filter 230 disposed apart from each other with a predetermined interval are disposed on an insulation substrate 210, and an overcoat 250 is disposed on the light blocking member 220 and the color filter 230. The light blocking member 220 may be disposed further on the lower panel 100.

A common electrode 270 made of a transparent conductor or metal such as ITO or IZO is formed on the overcoat 250, and an alignment layer 21 is disposed on the common electrode 270. The alignment layer 21 may be a vertical alignment layer.

The liquid crystal layer 3 provided between the lower panel 100 and the upper panel 200 includes liquid crystal molecules having dielectric anisotropy. The liquid crystal molecules are aligned such that longitudinal axes thereof may be disposed substantially vertically with respect to the surfaces of the display panels 100 and 200 when no electric field is generated in the liquid crystal layer 3.

The pixel electrode 191, to which the data signal is applied, generates an electric field together with the common electrode 270 of the upper panel 200 to determine the direction of the liquid crystal molecules of the liquid crystal layer 3 between the electrodes 191 and 270. A change of polarization of the light applied to the liquid crystal layer 3 depends on the slanted degree of the liquid crystal molecules, and the change of polarization is indicated as a change of transmittance by the polarizer, by which the liquid crystal display displays the image.

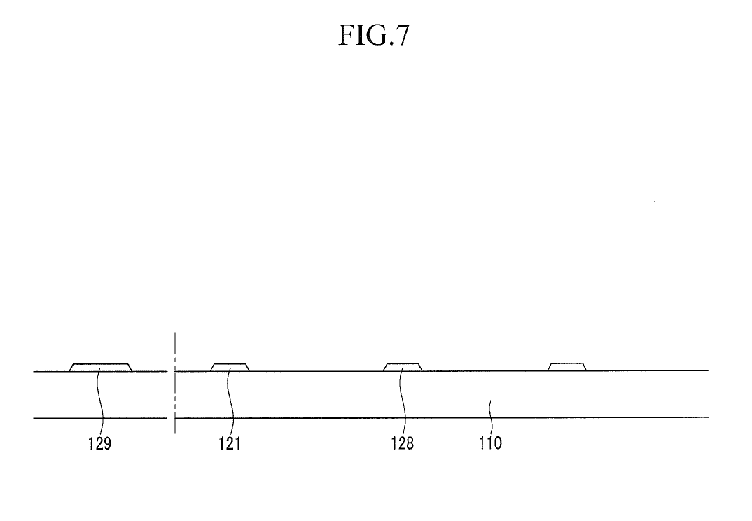

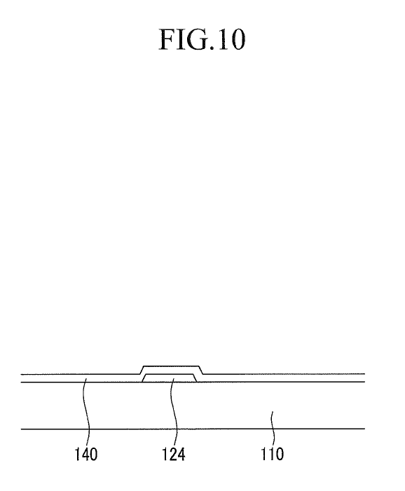

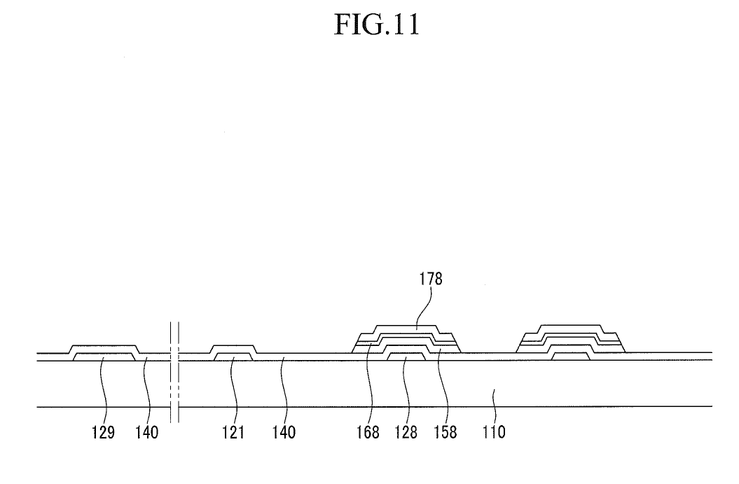

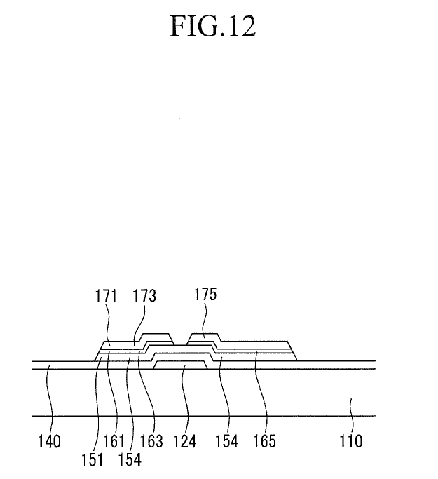

FIGS. 7 to 18 are cross sectional view showing an exemplary embodiment of a method for manufacturing a lower panel of a liquid crystal display of FIGS. 3 and 6.

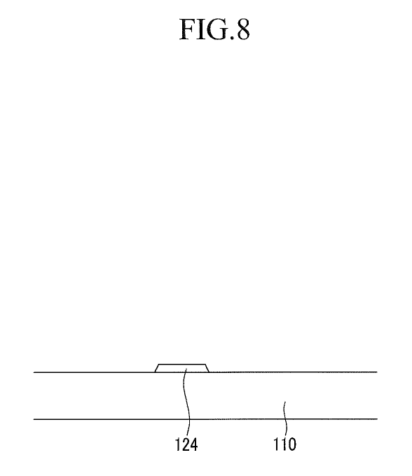

Referring to FIGS. 7 and 8, a gate conductive layer (not shown) is stacked with a low-resistance metal such as an aluminum group metal, a silver group metal, and a copper group metal on the insulation substrate 110 made of transparent glass, and the gate conductive layer is photo-etched to form gate conductors 121 and 128 including a plurality of gate lines 121, a plurality of gate electrodes 124 protruded from the gate lines 121, an end part 129 with a width greater than a width of the gate line 121, and a plurality of first conductors 128.

The gate conductive layer is provided on the insulation substrate 110 using sputtering, electroplating, electroless plating, inkjet printing, or gravure printing, for example.

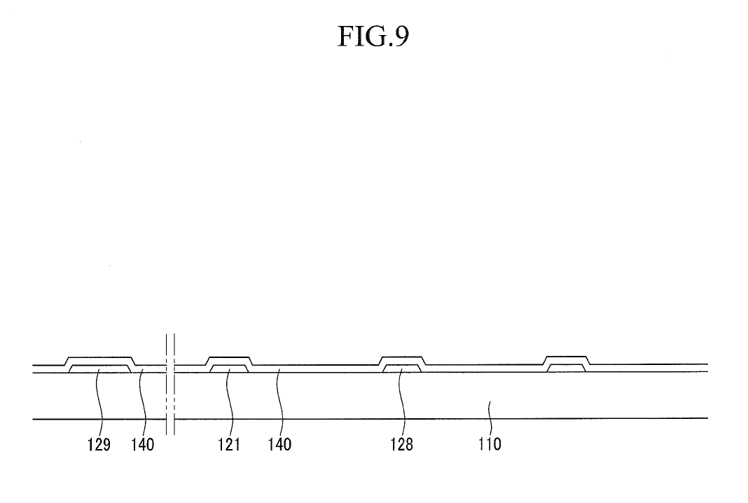

Referring to FIGS. 9 to 12, a gate insulating layer 140 including an organic insulator or inorganic insulator is provided on the gate conductors 121 and 128.

A semiconductor layer (not shown) and an impurity-doped semiconductor layer (not shown) are sequentially stacked on the gate conductors 121 and 128 and the gate insulating layer 140 using chemical vapor deposition, for example. A data conductive layer (not shown) may be provided using sputtering and is photo-etched to form data conductors 171, 175 and 178.

A semiconductor island 158, an ohmic contact island 168 and a second conductor 178 are provided on the first conductor 128. A semiconductor stripe 151, an ohmic contact stripe 161 and a data line 171 are provided to cross the gate line 121. Also, a thin film transistor is formed by providing a first semiconductor 154, a pair of ohmic contacts 163 and 165, a source electrode 173 and a drain electrode 175 on the gate electrode 124. A first semiconductor 154 is provided to be exposed between the source electrode 173 and the drain electrode 175.

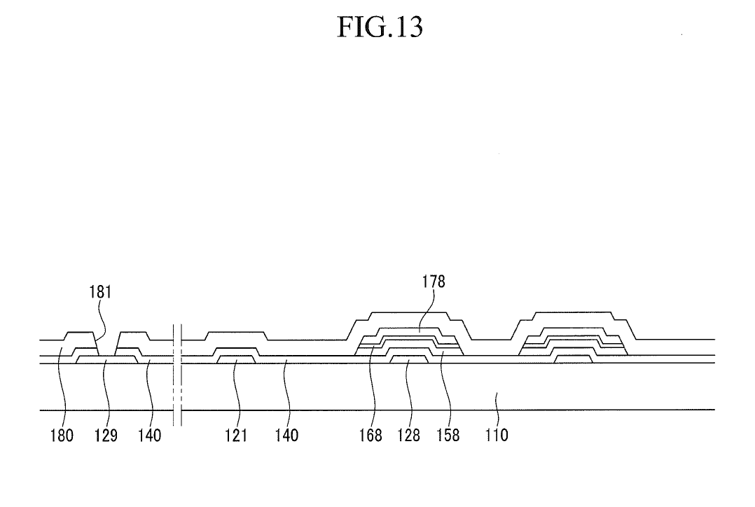

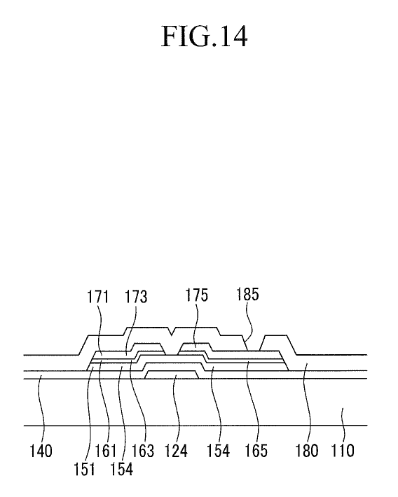

Referring to FIGS. 13 and 14, a plurality of contact holes 181 and 185 is formed in a passivation layer 180 by providing, e.g., coating or stacking, an organic insulating material or an inorganic insulating material on the data conductors 171, 175 and 178, the exposed first semiconductor 154 and the gate insulating layer 140, and then etching the provided organic or inorganic insulating material. In such an embodiment, the gate insulating layer 140 is also etched to form a contact hole 181 that exposes the end part 129 of the gate line 121.

The first conductor 128, the gate insulating layer 140, the semiconductor island 158, the ohmic contact island 168, the second conductor 178 and the passivation layer 180 collectively form the dams 112 and 113. The dams 112 and 113 are formed by a plurality of layers provided, e.g., stacked, on the substrate 110 to form the display signal lines 121 and 171 and the thin film transistor. In an exemplary embodiment, a mask and an additional process may be performed to form the dams 112 and 113.

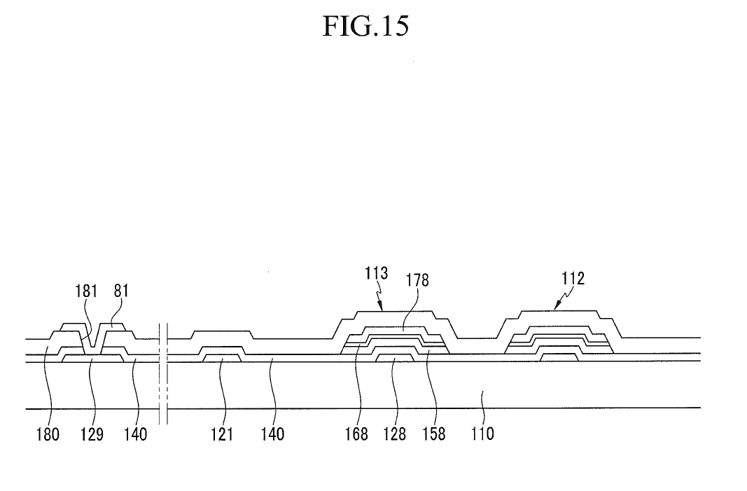

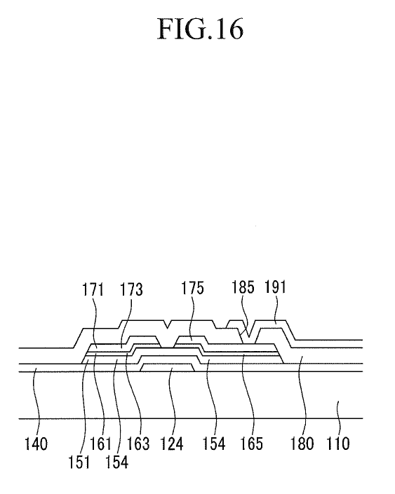

Referring to FIGS. 15 and 16, an IZO or ITO layer is provided, on the passivation layer 180 to form a plurality of pixel electrodes 191 and pads 81. In an exemplary embodiment, the IZO or ITO layer may be deposited and patterned on the passivation layer 180 through sputtering.

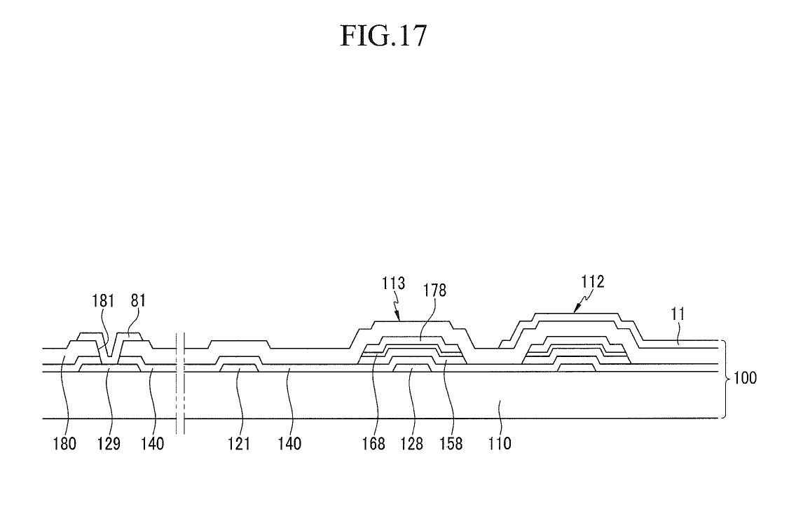

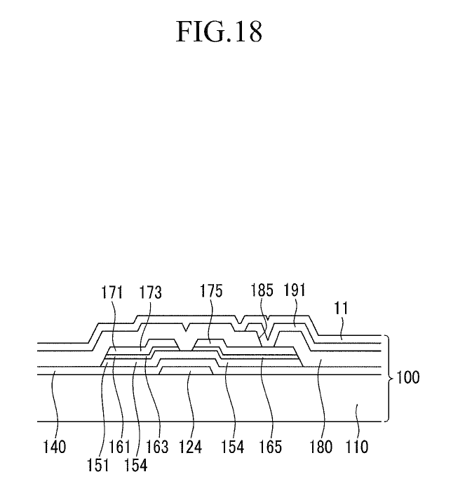

Referring to FIGS. 17 and 18, a polymer material such as a polyimide may be provided, e.g., deposited, on the passivation layer 180 to form an alignment layer 11.

The dam 112 controls spreading of the alignment layer 11 not to be substantially outside the display area (DA of FIG. 1).

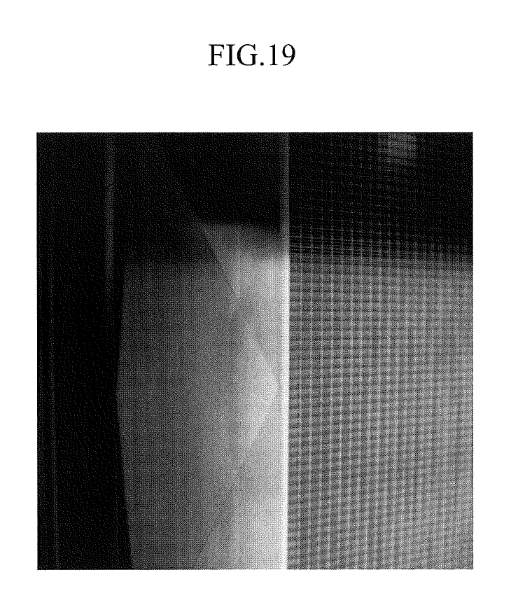

FIG. 19 is a plan view of an exemplary embodiment of a liquid crystal display, where no dam is provided in a dummy area.

Referring to FIG. 19, the alignment layer in the dummy area is spread wider than the alignment layer spread in the wiring unit is. The triangular dummy area between the wiring units has no steps, unlike the wiring unit having steps. In such an embodiment, the height of the dummy area with respect to the substrate is greater than the height of the wiring unit with respect to the substrate such that the alignment layer in the dummy area is spread wider than the alignment layer in the wiring unit. Accordingly, the non-display area of the liquid crystal display is substantially expanded.

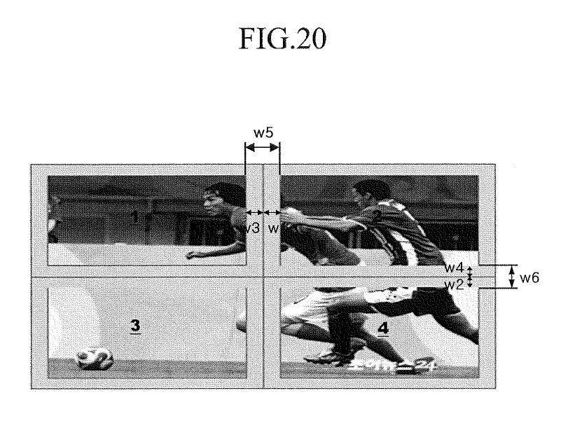

FIG. 20 is a plan view of an exemplary embodiment of a tiled display, including a plurality of liquid crystal displays connected to each other.

Referring to FIG. 20, the tiled display includes four liquid crystal displays arranged in a 2×2 matrix form. Each of the four liquid crystal displays may an exemplary embodiment of the liquid crystal displays set forth herein. In one exemplary embodiment, for example, the four liquid crystal displays may be the exemplary embodiment of the liquid crystal displays shown in FIG. 1. A large-size tiled display may be realized using relatively small liquid crystal displays.

In an exemplary embodiment, widths w5 and w6 of a bezel provided between the liquid crystal displays of the tiled display may be substantially reduced to acquire a natural screen connection between the liquid crystal displays. In an exemplary embodiment, widths w1 to w4 of the non-display area of each of the four liquid crystal displays are reduced to reduce the widths w5 and w6 of the bezel of the tiled display.

In an exemplary embodiment, a driver of each of the four liquid crystal displays may be disposed in the left side portion of the non-display area and the upper portion of non-display area of the liquid crystal display, as shown in FIG. 1, and a driver may not be provided in the right side portion of the non-display area and the lower portion of the non-display area. The width w1 of the left non-display area and the width w2 of the top non-display area of each liquid crystal display may be substantially reduced by forming a dam in the dummy area of each liquid crystal display.

In one exemplary embodiment, for example, the widths w5 and w6 of the bezel may be less than about 5.8 millimeters (mm). In such an embodiment, the width w3 of the right side portion of the non-display area of a first liquid crystal display (Number 1) may be less than about 1.9 mm, and the width w1 of the left side portion of the non-display area of a second liquid crystal display (Number 2) may be less than about 3.8 mm. Further, the width w4 of the lower portion of the non-display area of the second liquid crystal display (Number 2) may be less than about 1.9 mm, and the width w2 of the upper portion of non-display area of a fourth liquid crystal display (Number 4) may be less than about 3.8 mm.

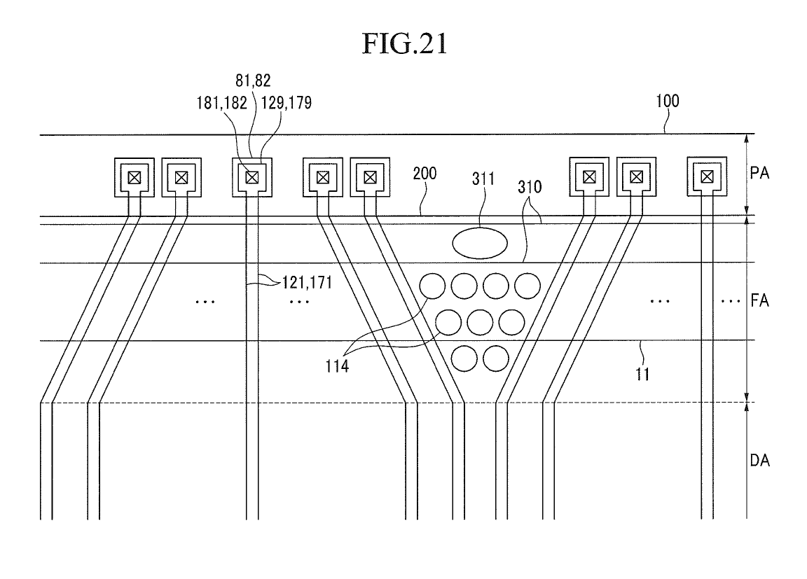

FIG. 21 is a top plan view of an alternative exemplary embodiment of a liquid crystal display. The elements in FIG. 21 have been labeled with the same reference characters used to describe the same or like elements in FIG. 2, and any repetitive detailed description thereof will hereinafter be omitted or simplified. FIG. 21 is substantially the same as FIG. 2 except the shape of a dam 114. The above-described contents on the cross-section of the dam are applicable to the cross-section of the dam 114 of FIG. 21.

Referring to FIG. 21, a plurality of dams 114 is disposed in the dummy area D. The dams 114 of the dummy area D have a shape different from a shape of a portion of the display signal lines 121 and 171 of the wiring unit. The planar shape of the dams 114 is different from the planar shapes of the display signal lines 121 and 171 of the wiring unit.

The planar shapes of the dams 114 are circular or oval. The dams 114 in the dummy area D are disposed substantially close to each other.

The dams 114 generate steps in the dummy area D, and spreading of the alignment layer 11 is prevented by the steps. Also, the dams 114 in the dummy area D interrupt progressing of the alignment layer 11 toward a portion between the dams 114. Therefore, the non-display area of the liquid crystal display is substantially reduced.

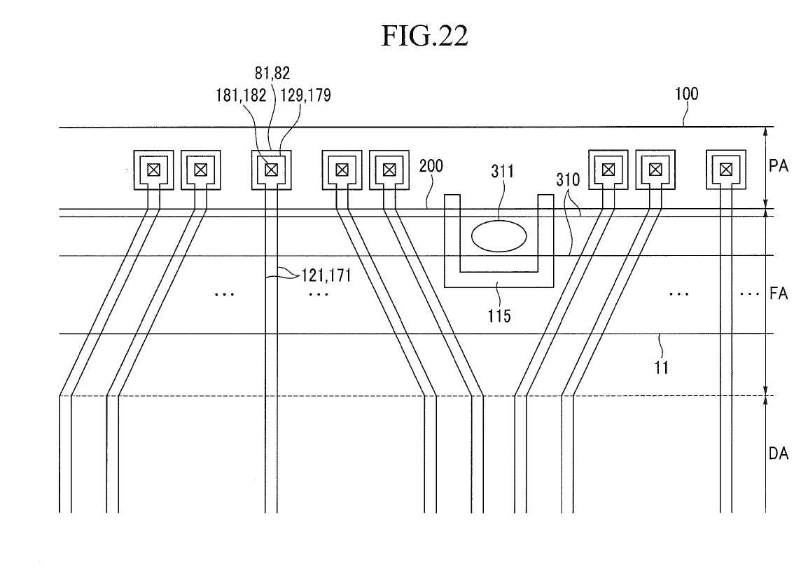

FIG. 22 is a top plan view of another exemplary embodiment of a liquid crystal display. The elements in FIG. 22 have been labeled with the same reference characters used above to describe the same or like elements in FIG. 2. FIG. 22 is substantially the same as the FIG. 2 except the shape of a dam 115. The contents on the cross-sections of the dams described above are applicable to the cross-section of the dam 115 of FIG. 22.

Referring to FIG. 22, the dam 115 is disposed in the dummy area D. The dam 115 has a shape different from the shape of the display signal lines 121 and 171 of the wiring unit. The planar shape and width of the dam 115 may be different from the planar shapes and widths of the display signal lines 121 and 171 of the wiring unit. In the dummy area D, the dam 115 is disposed around the short bar 311. In the dam 115, a part adjacent to the boundary of the display area DA may be substantially parallel to the boundary of the display area DA. In such an embodiment, the dam 115 is not disposed between the short bar 311 and the boundary of the pad area PA adjacent to the short bar 311. In an exemplary embodiment, the dam 115 may have a U-like shape, as shown in FIG. 22, but not being limited thereto. In an alternative exemplary embodiment, the dam 115 may have various shapes to surround at least a portion of the short bar 311.

The dam 115 of the dummy area D forms a step in the dummy area D, and effectively prevents the alignment layer 11 from spreading over the dam 115 by the step. In such an embodiment, spreading of the alignment layer 11 outside the display area DA is controlled by the dam 115. Also, the dam 115 effectively prevents the alignment layer 11 from covering the short bar 311. Therefore, the non-display area of the liquid crystal display is substantially reduced.

According to the exemplary embodiments set forth herein, the non-display area of a liquid crystal display is substantially reduced by providing the dam in the dummy area, and a manufacturing method thereof are provided.

The dam forms the steps in the dummy area, and spreading of the alignment layer is prevented by the steps. That is, spreading of the alignment layer outside the display area is substantially reduced by the dam. Further, spreading of the alignment layer is controlled by the dam, thereby preventing the alignment layer from covering the short bar. Therefore, the non-display area of the liquid crystal display is substantially reduced.

In exemplary embodiment, the dam may be provided without a mask and an additional process since the dam is provided using a plurality of layers provided on the substrate to provide the display signal line and the thin film transistor.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a first substrate including a display area and a fan-out area;
a plurality of pixels disposed in the display area;
a dam disposed in the fan-out area; and
a plurality of display signal lines disposed on the first substrate,
wherein the plurality of display signal lines is connected to the plurality of pixels in the display area,
wherein the plurality of display signal lines includes a plurality of wiring units in the fan-out area,
wherein the dam is disposed in a dummy area of the fan-out area between the plurality of wiring units, and
wherein a shape of the dam is different from a shape of the plurality of wiring units.

2. The liquid crystal display of claim 1, wherein
a height of the dam with respect to the first substrate is greater than or equal to a height of the plurality of wiring units with respect to the first substrate.

3. The liquid crystal display of claim 1, wherein
each of the plurality of pixels include a switching element, and
the switching element is formed by stacking a plurality of layers on the first substrate.

4. The liquid crystal display of claim 3, wherein
the dam is formed by the plurality of layers stacked on the first substrate.

5. The liquid crystal display of claim 4, further comprising:
a gate conductor disposed on the first substrate and including a first conductor, a gate line and a gate electrode connected to the gate line;
a gate insulating layer disposed on the gate conductor on the first substrate;
a data conductor disposed on the gate insulating layer and including a second conductor, a data line, a drain electrode and a source electrode connected to the data line; and
a passivation layer disposed on the gate insulating layer and the data conductor,
wherein the switching element includes the gate electrode, the drain electrode and the source electrode, and
wherein the dam includes the first conductor, the gate insulating layer, the second conductor and the passivation layer.

6. The liquid crystal display of claim 5, wherein
the switching element further includes a first semiconductor, and
the first semiconductor is disposed on the gate insulating layer and overlapping the drain electrode and the source electrode.

7. The liquid crystal display of claim 6, wherein
the dam further includes a semiconductor island, and
the semiconductor island is disposed between the gate insulating layer and the second conductor.

8. The liquid crystal display of claim 7, wherein
each of the plurality of pixels further include a pixel electrode, and
the pixel electrode is disposed on the passivation layer and electrically connected to the drain electrode.

9. The liquid crystal display of claim 8, further comprising:
an alignment layer disposed on the passivation layer and the pixel electrode.

10. The liquid crystal display of claim 9, wherein
the plurality of display signal lines includes the gate line and the data line.

11. The liquid crystal display of claim 1, wherein
a planar shape of the dam is a polygon, and
a planar shape of the dummy area is substantially similar to the planar shape of the dam.

12. The liquid crystal display of claim 11, wherein
the planar shape of the dam is trapezoidal or triangular.

13. The liquid crystal display of claim 11, wherein
a side of the dam adjacent to a boundary of the display area and the fan-out area is substantially parallel to the boundary of the display area and the fan-out area.

14. The liquid crystal display of claim 13, wherein
the dam includes a first dam and a second dam, and
a distance between the first dam and the second dam is greater than a distance between the dam and an adjacent display signal line of the plurality of display signal lines.

15. The liquid crystal display of claim 1, further comprising:
a second substrate disposed opposite to the first substrate;
a liquid crystal layer disposed between the first substrate and the second substrate; and
a sealant which bonds the first substrate and the second substrate to each other.

16. The liquid crystal display of claim 15, further comprising:
a common electrode disposed on the second substrate.

17. The liquid crystal display of claim 16, wherein
the sealant includes a short bar, and
the short bar is connected to the common electrode on the second substrate.

18. The liquid crystal display of claim 17, wherein
the short bar is disposed in the dummy area.

19. The liquid crystal display of claim 18, wherein
the dam includes at least one dam disposed between the display area and the short bar.

20. The liquid crystal display of claim 18, wherein
the dam is disposed surrounding at least a portion of the short bar.

21. A method for manufacturing a liquid crystal display, the method comprising:
providing a plurality of pixels in a display area on a first substrate including the display area and a fan-out area;
providing a dam in the fan-out area; and
providing a plurality of display signal lines including a plurality of gate lines and a plurality of data lines crossing the plurality of gate lines in an insulated manner on the first substrate,
wherein the plurality of display signal lines are connected to the plurality of pixels in the display area,
wherein the plurality of display signal lines includes a plurality of wiring units in the fan-out area,
wherein the dam is disposed in a dummy area of the fan-out area between the plurality of wiring units, and
wherein a shape of the dam is different from a shape of the plurality of wiring units.

22. The method of claim 21, further including:
providing a gate conductor including a first conductor, a gate line and a gate electrode connected to the gate line on the first substrate;
providing a gate insulating layer on the first substrate and the gate conductor;
providing a data conductor including a second conductor, a data line, a drain electrode, and a source electrode connected to the data line on the gate insulating layer; and
providing a passivation layer on the gate insulating layer and the data conductor,
wherein each of the plurality of pixels includes the gate electrode, the drain electrode and the source electrode, and
wherein the dam includes the first conductor, the gate insulating layer, the second conductor and the passivation layer.

23. The method of claim 22, further comprising
providing an alignment layer in the display area over the passivation layer.

24. The method of claim 23, further comprising
providing a sealant including a short bar on the first substrate, wherein the short bar is disposed in the dummy area.

25. The method of claim 24, further comprising:
providing a common electrode on the second substrate;
bonding the first substrate and the second substrate to each other through the sealant; and
providing a liquid crystal layer between the first substrate and the second substrate.

26. The method of claim 25, wherein
the short bar is connected to the common electrode by the bonding the first substrate and the second substrate.
